(19) United States
(12) Patent Application Publication
(10) Pub. No.: US 2019/0009785 A1
(43) Pub. Date: Jan. 10, 2019

(54) SYSTEM AND METHOD FOR DETECTING BULLYING OF AUTONOMOUS VEHICLES WHILE DRIVING

(71) Applicant: PANASONIC INTELLECTUAL PROPERTY MANAGEMENT CO., LTD., Osaka (JP)

(72) Inventors: Matthew John LAWRENSON, Lausanne (CH); Julian Charles NOLAN, Lausanne (CH); Norihiko KOBAYASHI, Tokyo (JP); Nobuhiro FUKUDA, Kanagawa (JP); Keiji NISHIHARA, Kanagawa (JP)

(73) Assignee: PANASONIC INTELLECTUAL PROPERTY MANAGEMENT CO., LTD., Osaka (JP)

(21) Appl. No.: 16/023,805

(22) Filed: Jun. 29, 2018

Related U.S. Application Data
(60) Provisional application No. 62/528,733, filed on Jul. 5, 2017.

(51) Int. Cl. B60W 40/04; G08G 1/017; G08G 1/01; G05D 1/00

(52) U.S. Cl. CPC B60W 40/04; G08G 1/017; G08G 1/0112; G05D 1/0088; B60W 2420/42; B60W 2550/302; B60W 2550/308; G05D 2201/0213; B60W 2420/52; B60W 2750/40

(57) ABSTRACT

A method is provided for detecting a bullying event. The method includes collecting, using a plurality of autonomous vehicle (AV) sensors provided on the AV, sensor data of an interaction between the AV and another vehicle. Once collected, the collected sensor data is stored in a memory, and a bullying signature is retrieved from the memory. The method further includes comparing, via a processor, the collected sensor data and attributes of the bullying signature for determining whether a bullying event has been detected. When a similarity between the collected sensor data and the attributes of the bullying signature is determined to be above a predetermined threshold, the method determines that the collected sensor data corresponds to a bullying event. In response to the detection, the method generates a bullying event flag for the bullying event.

### CROSS-REFERENCE TO RELATED APPLICATION(S)

The present application claims the benefit of U.S. Provisional Patent Application No. 62/528,733 filed on Jul. 5, 2017. The entire disclosure of the above-identified application, including the specifications, drawings and/or claims, is incorporated herein by reference in its entirety.

### BACKGROUND

### 1. Field of the Disclosure

The present disclosure relates to an autonomous vehicles, artificial intelligence (AI) algorithms and machine learning of autonomous vehicles. More particularly, the present disclosure relates to autonomous vehicles and their interactions with aggressive driving patterns.

### 2. Background Information

A. Autonomous Vehicles

An autonomous vehicle (AV) is a vehicle capable of sensing its location, details of its surrounding environment and navigating along a route without needing a human driver. In order to achieve this, a computer of the autonomous vehicle may collect data from its sensors, and then executes algorithms in order to decide how the vehicle should be controlled, which direction to take, what speed (or range of speeds) the autonomous vehicle should be driven, when and how to avoid obstacles and the like.

Various levels of automation have been defined. For example, Level 0 automation may indicate no autonomous control is used. Level 1 automation, on the other hand, may add some basic automation aimed at helping a human driver rather than fully controlling the vehicle. Level 5 automation may be a vehicle that is able to drive with no human intervention. In this regard, Level 1 automation vehicles may have at least some sensors (e.g., back up sensors), while Level 5 vehicles will have significant number of sensors to provide significant sensing capability.

Considering that Level 1 automation vehicles include some automation, the over-arching term of autonomous vehicle may also include many vehicles on the road today, such as those where some form of driver assistance may be used (e.g., lane guidance or crash avoidance systems).

While some basic automation may be provided by explicitly programming rules to be followed on the occurrence of certain scenarios, due to the complexity of operating a vehicle on the open road, machine learning is often employed to create a system able to operate the vehicle. Machine learning may refer to a technique used in computer science that allows a computer to learn a response to a task or stimulus without being explicitly programmed to do so. Therefore, by providing many examples of driving scenarios, a machine learning algorithm may learn responses to various scenarios. This learning can then be used to operate the vehicle in future instances.

B. Mixed-Vehicle-Type Road Use

For the foreseeable future, it is likely that roads will be shared by vehicles of differing automation levels. While vehicles capable of full automation (e.g., Level 5 automation vehicles) may be presently unavailable commercially, vehicles with Level 1 and Level 2 automation systems are already commercially available. Further, Level 3 and potentially also Level 4 automation systems are currently being tested by various automotive and system manufacturers.

Hence any automation system being used on the road may need to be able to cope with interactions with other vehicles with various levels of human/automated control.

### BRIEF DESCRIPTION OF THE DRAWINGS

FIG. 1 shows an exemplary general computer system in an autonomous vehicle that is configured to detect and respond to a bullying activity, according to an aspect of the present disclosure;

FIG. 2 shows an exemplary environment in which bullying is detected, according to an aspect of the present disclosure;

FIG. 3 shows an exemplary system configuration for detecting bullying activity, according to an aspect of the present disclosure;

FIG. 4A shows an exemplary method for detecting bullying activity, according to an aspect of the present disclosure;

FIG. 4B shows an exemplary method for registering a new bullying signature, according to an aspect of the present disclosure;

FIG. 4C shows an exemplary method for determining a countermeasure, according to an aspect of the present disclosure; and

FIG. 5 shows an exemplary data flow for detecting bullying activity, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

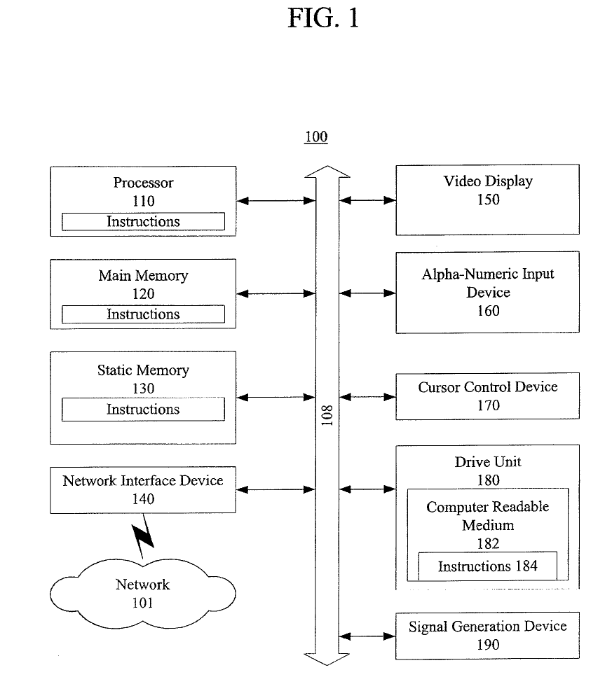

FIG. 1 shows an exemplary general computer system in an autonomous vehicle that is configured to detect and respond to a bullying activity, according to an aspect of the present disclosure.

A computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a communications device, a control system, a web appliance, a network router, switch or bridge, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

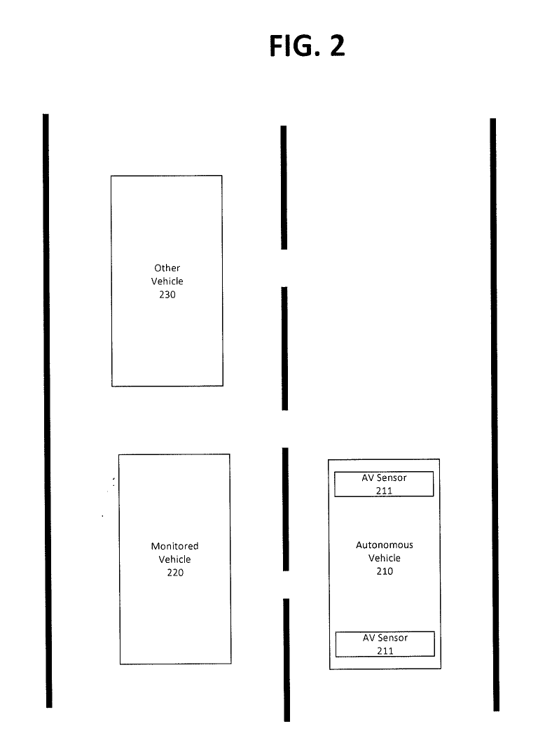

FIG. 2 shows an exemplary environment in which a bullying event is detected, according to an aspect of the present disclosure.

For an autonomous vehicle (AV) to operate properly, the autonomous vehicle relies on very detailed maps, such as high-definition (HD) maps, rather than on Global Positioning System (GPS) signals. The HD maps may collect various data using various autonomous vehicle sensors with respect to its surrounding environment to identify its location and to perform operation of the autonomous vehicle. More specifically, the autonomous vehicle sensors may collect data of surrounding static physical environment, such as nearby buildings, road signs, mile markers and the like, for determining its respective location. Further, autonomous vehicle sensors may also collect data of nearby moving objects, such as other vehicles, to detect potential dangers and to direct corresponding actions thereto.

Based on the detection of potential dangers, an autonomous vehicle may learn to respond to the potential dangers by performing a corresponding action or type of action. For example, if the autonomous vehicle detects that another vehicle is following the autonomous vehicle within a predetermined distance for a predetermined period of time (e.g., tailgate), the autonomous vehicle may detect such stimuli as a potential danger. Other examples of potential dangers or stimulus to which the autonomous vehicle may respond may also include, without limitation, flashing of lights, excessive honking, angle of approach, speed of approach, erratic behaviour (e.g., frequent swerving), frequent changing of lanes, and the like. Upon one or more iterations of responding to a particular type of potential danger or stimuli, the autonomous vehicle may learn to perform the corresponding action as a matter of course when detecting the particular type of potential danger. The autonomous vehicle may also determine to respond to such stimuli by changing lanes or speeding up to mitigate against the detected stimulus or potential danger. In an example, the autonomous vehicle may respond differently to a detected type of potential danger or stimulus.

Although such reaction may be machine learned or programmed to mitigate risks of potential dangers, malicious parties may induce such stimulus to illicit a corresponding response for a malicious purpose. For example, a malicious party may opt to tailgate an autonomous vehicle repeatedly to force the autonomous vehicle to constantly change lanes. Such behaviour may cause the autonomous vehicle to operate in a less than optimal manner or in a less efficient manner (e.g., longer trip times, lower fuel efficiency, unnecessary use of resources, such as brake pads and the like), and may be identified as a bullying behaviour. More specifically, a stimulus or an action by another vehicle resulting in a less than optimal manner above a reference threshold (e.g., increase of travel time more than 5 minutes) may be referred to as a bullying behaviour, action or stimulus. Although the bullying behaviour may be an intentional act by another, it may also include reckless actions by less experienced drivers or a malfunction of a vehicle (e.g., error in detecting safe following distance). For example, although a following distance of two seconds may be considered safe during normal weather conditions, a following distance of two seconds may be considered as potentially dangerous during more slippery road conditions (e.g., during rain or snow). In this regard, a determination of a bullying behaviour may be further determined in view of environmental factors. In an example, environmental factors may include, without limitation, lighting conditions, weather conditions, traffic conditions, presence of particular events (e.g., construction) or emergency vehicles, and the like.

Further, vehicles engaging in the bullying activity may be identified as a bullying vehicle. The bullying vehicle may be another autonomous vehicle or a normal vehicle operated by another person. Also in an example, the bullying vehicle may potentially include a vehicle belonging to an organization having a large number of offending vehicles (e.g., a particular taxi company).

In an example, if a first automated system (e.g., an autonomous vehicle) learns a response to a certain action, or type of action, then it is likely to perform this learned response consistently in response to the certain action or type of action. If the stimuli-response is known or observed by a second vehicle operator (e.g., either human drivers or another automated autonomous vehicle) then the other vehicle operators may intentionally perform the known or observed stimuli in order to obtain the known or observed response. Where the known response results in the first the first automated system to operate in a non-optimal way (e.g., unnecessary breaking, changing of lanes, lowering of speed and etc.), a stimulus causing the known or observed response may be considered as a bullying action or behaviour. The issue of bullying action or behaviour may be relevant where the second vehicle is driven or operated by another automated system to intentionally cause a non-optimal performance of the first vehicle.

In an example, a human driver may wish to bully an autonomous vehicle for entertainment reasons. For example, a teenage driver may want to show off to the driver's friends by making an autonomous vehicle behave in a particular way. Alternatively, the human driver may engage in the bullying behavior to gain an advantage in traffic. For example, a human driver may know that if he drives directly towards an autonomous vehicle that vehicle will move or break, allowing the human driver's vehicle to have a quicker route through traffic. The resulting quicker journey for the human driven vehicle may be at the expense of slower journey for the autonomous vehicle. Also, the human driver may engage in the bullying behavior for a malicious reason. For example, a person might have a grudge against a certain company operating autonomous vehicles or a passenger riding in a particular autonomous vehicle. Further, a competing company, such as a taxi company operated by human drivers, may opt to engage in bullying behaviour to show less optimal performance by autonomous vehicles to gain competitive advantage in a market place.

Further, a first autonomous vehicle may be programmed to bully a second autonomous vehicle due to, for example, the first autonomous vehicle being operated by a business-rival of the company operating the second autonomous vehicle. For example, if a first taxi company is able to make journeys for a second taxi company slower and less pleasant, then the first taxi company may be able to capture customers from the second company. Similarly, vendors of autonomous vehicles may wish to make their vehicles more attractive by having them behave in a more dominant or bullying manner on the road.

However, such bullying behaviour or actions by the human driver of other autonomous vehicles may cause certain safety risks. For example, a reaction of the bullied vehicle may be unpredictable. For example, at least because a reaction to a stimulus by the autonomous vehicle may be learned via machine learning, perhaps even on a vehicle-by-vehicle basis, the reaction of each autonomous vehicle or groups of autonomous vehicles (e.g., manufactured or operated by different entities) may be different due to their different histories. Further, the reaction may be different to that expected by the operator of the bullying vehicle, perhaps due to a software update in the bullied vehicle, or the bullied vehicle being operated in a different setting than that expected by the bullying vehicle. Since different manufacturers may specify different algorithms, which may cause corresponding AVs to behave differently, reactions to a specific stimulus may not be uniform. Also, if the stimulus being subjected to by the bullied autonomous vehicle has not yet been learned, a resulting reaction may be particularly erratic as it may push the autonomous control algorithms beyond the training data or existing data provided. The reaction of the bullied vehicle may also be unexpected to a third vehicle, possibly human-driven, and the third vehicle may struggle to react in a safe manner as a reaction by the autonomous vehicle may be different from those of a human driver.

Accordingly, such risks may lead to accidents, leading to costs to the owners of the bullied vehicles, and potential harm to the passengers of the bullied vehicles.

In view of such risks, some companies have attempted to provide a solution by collecting video data via cameras mounted in or on the AVs, and analysing the collected video data to make an assessment of driving operations of other vehicles. However, as such technology is based on the analysis of video data, the bullying may be more difficult to detect for less erratic or less drastic behaviour, which may still cause sub-optimal performance by the bullied vehicle but not detected in the video data. For example, if the bullied autonomous vehicle reacts smoothly and early, then the bullying incident or behaviour may not be as pronounced and may not be captured by the video data. In these regards, aspects of the present disclosure provide a technical solution to the noted technical deficiency in conventional vehicle behaviour monitoring technology.

As illustrated in FIG. 2, autonomous vehicle (AV) 210 includes multiple autonomous vehicle sensors 211, which may be located at various parts of the autonomous vehicle 210. Although the autonomous vehicle sensors 211 are illustrated as being located at front and rear of the autonomous vehicle 201, aspects of the present disclosure are not limited thereto, such that the autonomous vehicle sensors 211 may be located at other locations of the autonomous vehicle 210, such as side or corner portions of the autonomous vehicle 210.

In an example, each of the autonomous vehicle sensors 211 may be a same type of sensor or a different type of sensor. The autonomous vehicle sensors 211 may include, without limitation, cameras, a LIDAR (actuators, a light detection and ranging) system, a radar system, acoustic sensors, infrared sensors, image sensors, other proximity sensors, and the like. In an example, data collected by autonomous vehicle sensors may be referred to as sensor data. The sensor data may be collected and temporarily stored for uploading.

The autonomous vehicle sensors 211 may detect its physical surrounding environment, including buildings, mile markers, other physical structures, as well as other vehicles, such as a monitored vehicle 220 and other vehicle 230. In an example, each of the monitored vehicle 220 and the other vehicle 230 may be an autonomous vehicle or a human operated vehicle.

In an example, the monitored vehicle 220 may be a vehicle that is identified as being a potential hazard based on its proximity to the autonomous vehicle 210 based on sensor data of the autonomous vehicle sensors 211. The monitored vehicle 220, based on its behavior with respect to the autonomous vehicle 210, may be identified as a bullying vehicle. For example, if the monitored vehicle 220 acts in a way to cause potential danger to the autonomous vehicle 210 or cause the autonomous vehicle 210 to operate in a less than optimal manner above a predetermined threshold, actions of the monitored vehicle 220 may be identified as a bullying behavior or action. The bullying actions of the monitored may be intentional, reckless, or caused by a malfunction of the monitored vehicle. Although identification of bullying behavior was identified with respect to the autonomous vehicle 210, aspects of the present application are not limited thereto, such that bullying behavior may also be monitored with respect to other vehicles, even if the autonomous vehicle 210 is not involved in the altercation, for purposes of maintaining public safety. For example, a bullying behavior exhibited by vehicle A towards vehicle B may be observed by the autonomous vehicle 210 and reported to the authorities (e.g., police, insurance companies, and the like) by the autonomous vehicle 210.

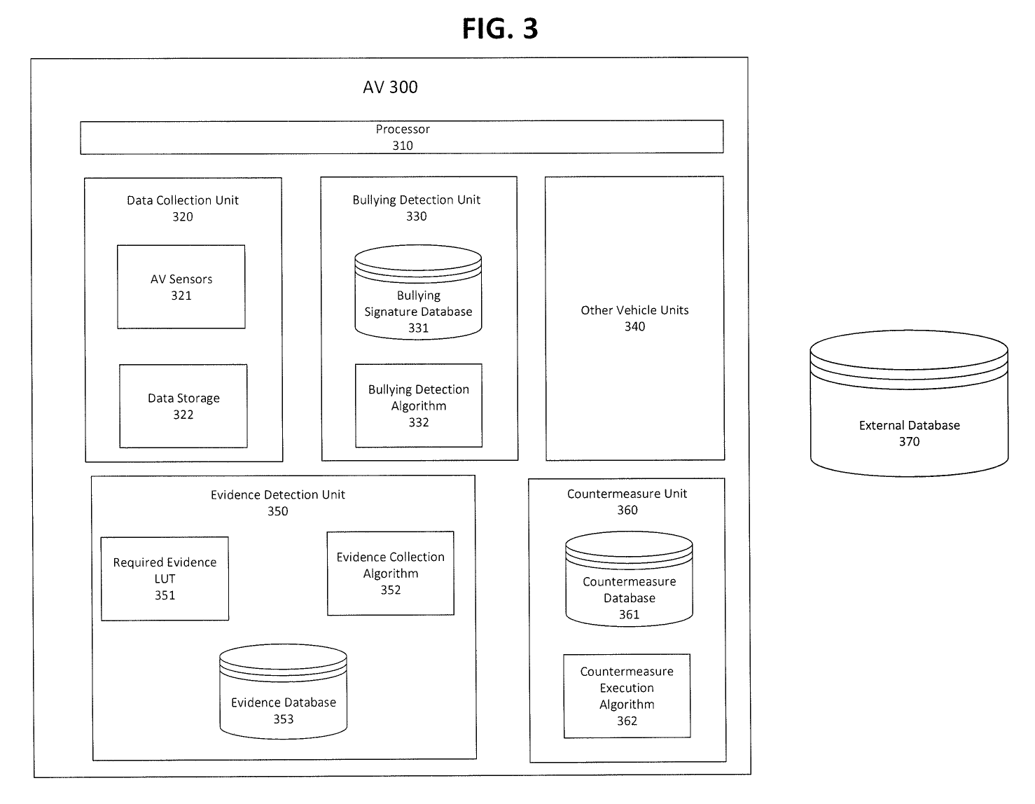

FIG. 3 shows an exemplary system configuration for detecting bullying activity, according to an aspect of the present disclosure.

A system included in an autonomous vehicle 300 for detecting bullying behavior and collecting corresponding evidence, as illustrated in FIG. 3, includes a processor 310, a data collection unit 320, a bullying detection unit 330, other vehicle units 340, an evidence detection unit 350, and a countermeasure unit 360. However, aspects of the disclosure are not limited thereto, such that some of the above noted units may not be included in the autonomous vehicle or that autonomous vehicle may include additional units. One or more of the above noted units may be implemented as circuits. Further, one or more of the above noted units may be included in a computer.

The processor 310 may interact with one or more of the data collection unit 320, the bullying detection unit 330, the evidence detection unit 340 and the countermeasure unit 360. The data collection unit 320 includes one or more autonomous vehicle sensors 321 and a data storage 322. The one or more autonomous vehicle sensors 321 may collect sensor data of surrounding environment, both static structures and moving objects, and transmits the collected sensor data to the data storage 322. The autonomous vehicle sensors 321 may include, without limitation, cameras, a LIDAR (actuators, a light detection and ranging) system, a radar system, acoustic sensors, infrared sensors, image sensors, other proximity sensors, and the like.

The bullying detection unit 330 includes a bullying signature database 331 and a bullying detection algorithm 332. The bullying detection unit 330 may receive sensor data as input and compare the received sensor data against data (e.g., bullying signature data) stored in the bullying signature database 331. Based on the comparison, a processor 310 of the autonomous vehicle 300 may determine that bullying behavior has been taken place, and generates a bullying event to trigger collection of evidence. Further, the bullying detection algorithm 332 may generate a bullying event flag for communicating the bullying event to other parts of the system.

The comparison data stored in the bullying signature database 332 may indicate a pattern of behavior or actions that constitutes a bullying behavior. For example, the comparison data may include data indicating following distance of less than two seconds for an extend period of time. Such data patterns may be identified as bullying signatures. The bullying signatures may be manually defined or automatically generated based on artificial intelligence or machine learning.

For example, an autonomous vehicle may drive along a determined route during a normal course of operation. While driving along the determined route, the autonomous vehicle may interact with other vehicles present along the determined route. An operation of the autonomous vehicle may be affected by other vehicles present along the determined route. An autonomous vehicle may have a set of journey parameters that may apply in a case no interactions with the other vehicles take place. The journey parameters may include, without limitation, journey time, expected changes in direction, speed and the like.

Further, when an autonomous vehicle interacts with one or more other vehicles, sensor data may be collected by one or more autonomous vehicle sensors of the AV. The sensor data collected may include, without limitation, speed, unplanned direction changes and the like. The collected sensor data may be stored in a memory or database of the autonomous vehicle or an external server. Further, sensor data relating to other vehicles during the interaction can be also stored. The sensor data collected may be stored temporarily before being stored as evidence or purged as unnecessary data. In addition, when the bullying behavior is detected, more extensive sensor data may be collected for evidentiary purposes.

The recorded interaction data can then be compared to an expected scenario, in which the autonomous vehicle is disadvantaged or where expected journey parameters have become worse. If the expected journey parameters are determined to be equal to or worse than the stored parameters, then the vehicle interaction may be identified as a candidate bullying signature.

Once a candidate bullying signature is identified, various processes may be performed to verify the candidate bullying signature as a valid bullying signature. For example, when vehicle interactions corresponding to the candidate bullying signature occurs a predetermined number of times, the candidate bullying signature may be verified as a valid bullying signature. The validated candidate bullying signature may be added to the bullying signature database 331.

The other vehicle units 340 of the autonomous vehicle 300 may include, without limitation, lighting systems, vehicle control systems (e.g., breaking, steering, etc.), and vehicle-to-vehicle communication systems. One or more of the other vehicle units 340 may be controlled to alert or notify authorities of the detected bullying activity. For example, when a bullying activity is detected, lights may be operated in a specific manner or pattern to alert nearby police vehicles of the bullying activity.

The evidence detection unit 350 includes a required evidence look-up-table (LUT) 351, an evidence collection algorithm 352, and an evidence database 353. The evidence detection unit 350, upon detection of a bullying event, may gather evidence data and store the collected evidence data in the evidence database 353. The evidence data to be stored, such as required evidence data, may include, without limitation, sensor data and/or supplemental data. A description of the required data may be stored in the required evidence LUT 351. The sensor data may be collected from one or more autonomous vehicle sensors 321 of the autonomous vehicle 300. Supplemental data includes environment data, such as, weather information, road condition information, lighting conditions, traffic condition information, and the like. The supplemental data may include other sensor collected by the autonomous vehicle sensors and/or received from an external database 370.

The countermeasure unit 360 may determine a most appropriate countermeasure once a bullying event is detected, and execute the determined countermeasure. The countermeasure unit 360 includes a countermeasure database 361 and a countermeasure execution algorithm 362. The countermeasure database 361 may store a set of processes or countermeasure instructions that can be executed by other sub-systems within the autonomous vehicle 300, such as the other vehicle units 340. More specifically, the countermeasure unit 360 may obtain some sensor data as input and calculate a value that is used to determine a most appropriate countermeasure. For example, if the approach speed of the bullying vehicle is greater than a predetermined value, then countermeasure A (e.g., changing of lanes) may be determined to be the most appropriate. However, if the approach speed is determined to be less than the predetermined value, then countermeasure B (e.g., speeding up) may be determined to be the most appropriate.

The countermeasure execution algorithm 362 may receive the determined countermeasure as an input and communicate with various other vehicle units to execute the determined countermeasure. For example, the determined countermeasure may include controlling of at least one of a lighting system, a braking system, a steering system, and the like. Countermeasures may include, without limitation, modifying speed or direction of vehicle, applying a lighting scheme to provide a visible indication that a bullying event has been detected, providing a warning/explanation to passengers regarding the bullying event, compiling a report/evidence that can be sent to an authority (e.g., police or insurance company), transmitting a report to an authority, or the like.

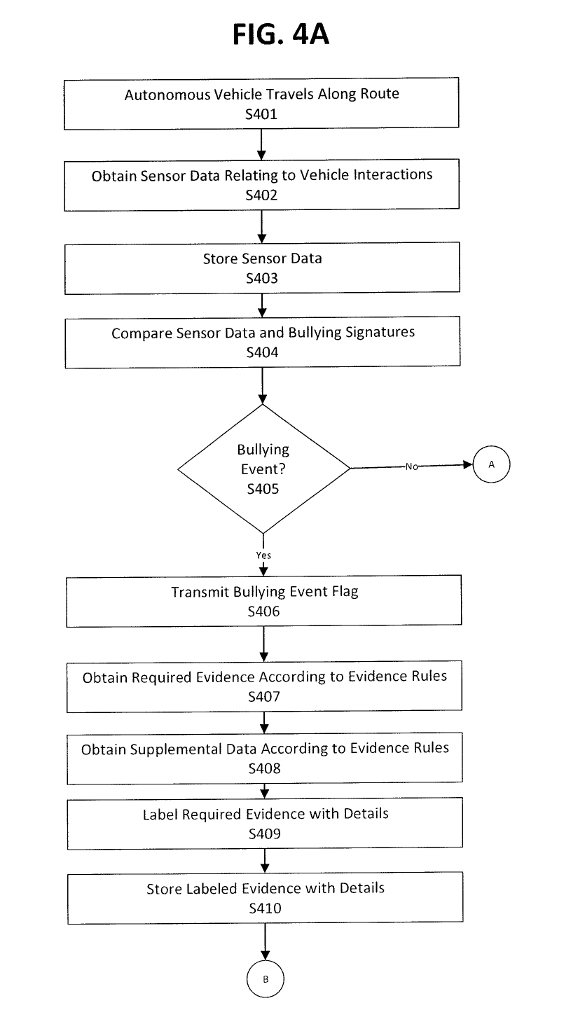

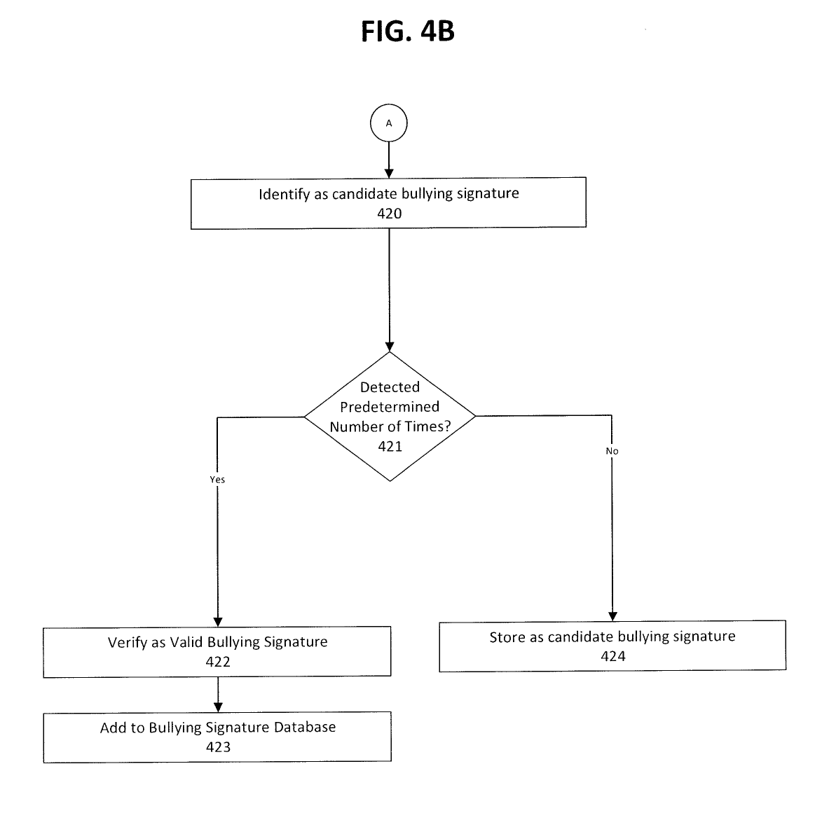

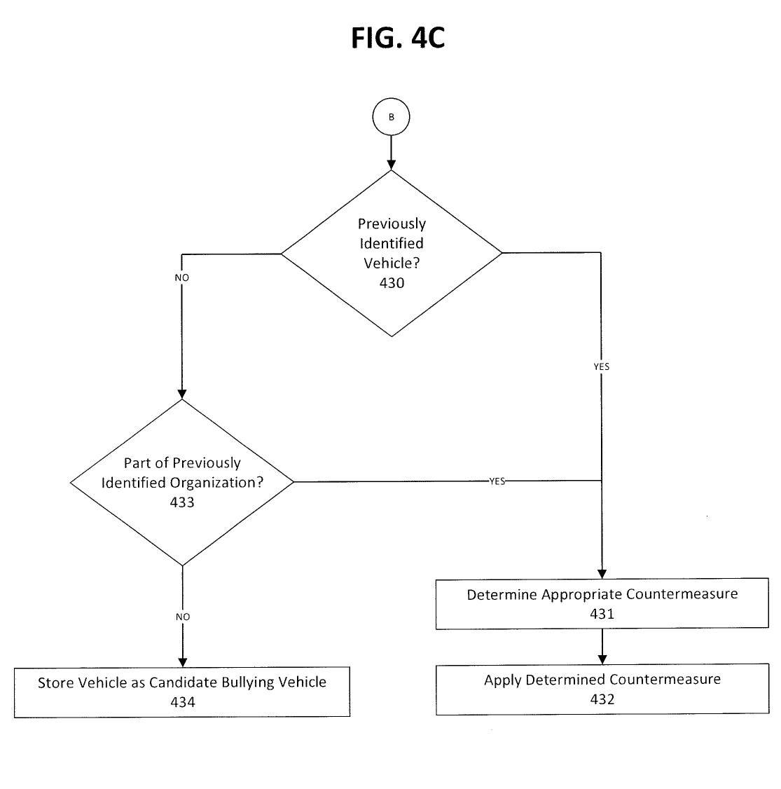

FIG. 4A shows an exemplary method for detecting bullying activity, according to an aspect of the present disclosure. FIG. 4B shows an exemplary method for registering a new bullying signature, according to an aspect of the present disclosure. FIG. 4C shows an exemplary method for determining a countermeasure, according to an aspect of the present disclosure.

In operation 401, an autonomous vehicle (AV) travels along a route. The autonomous vehicle may be traveling the route with other vehicles, which may include other AVs of varying autonomous control level settings as well as manually operated vehicles.

In operation 402, sensors included in the autonomous vehicle obtain or gather sensor data relating to interactions with other vehicles. In an example, the sensors included in the autonomous vehicle may include, without limitation, cameras, a LIDAR (actuators, a light detection and ranging) system, a radar system, acoustic sensors, infrared sensors, image sensors, other proximity sensors, and the like. The sensor data obtained may indicate, without limitation, a distance between the autonomous vehicle and other vehicles, an angle of approach by other vehicles, velocity at which other vehicles approach the AV, rate of change of velocity of other vehicles, frequency of breaking, and the like. Further, the sensor data may also capture environmental information that may affect determination of a bullying event.

In operation 403, the obtained sensor data is stored in a data storage of the AV. In an example, the obtained sensor data may be temporarily stored for analysis. The obtained sensor data may be periodically deleted from the data storage to free up space within the data storage. Further, in an example, the obtained sensor data may be stored in an external server prior to deletion thereof.

In operation 404, the obtained sensor data is transmitted to a bullying detection unit, which may be implemented as an integrated circuit within the AV. Bullying detection algorithm stored in the bullying detection unit may be executed to use the obtained sensor data in view of bullying signatures stored in a bullying signature database, which may be also stored in the bullying detection unit. More specifically, in an example, the bullying detection algorithm may use the obtained sensor data directly or use the obtained or stored sensor data to calculate an intermediate data set. For example, the intermediate data set may include, without limitation, an average rolling period, a minimum value from a set, mathematical operators, and the like. The obtained sensor data or the intermediate data set may be defined as comparison data.

Once the comparison data is obtained, the bullying detection algorithm may be executed to compare the comparison data with bullying signatures retrieved from the bullying signature database in operation 405. A determination of a match may be based on a number of stipulated parameters. For example, a match may be determined if a speed of approach and an angle of approach of the obtained sensor data match with a speech of approach and an angle of approach of a bullying signature stored in the bullying signature database. Further, a match may be determined if similarity between the datasets is within a predetermined tolerance. For example, a 90% match between the data sets may be determined to be a match.

If a match is determined in operation 405, the bullying detection algorithm transmits a bullying event flag to evidence collection algorithm stored in an evidence detection unit in operation 406. In an example, the bullying event flag may contain additional information to convey a class of bullying detected. In an example, bullying event class may include, without example, tailgating, aggressive breaking (e.g., in front of the AV), passing the autonomous vehicle with excessive speed, and the like. Different class may require different required evidence.

In operation 407, upon receipt of the bullying event flag, the evidence collection algorithm accesses the required evidence LUT to determine which sensor data should be stored or further collected. More specifically, if the bullying event flag indicates a particular class, the evidence collection algorithm may determine that the autonomous vehicle should collect or store specific sensor data corresponding to the particular class of the bullying event. For example, if the bullying activity is determined to be tailgating by the instigating vehicle, a following distance of the instigating vehicle to the autonomous vehicle may be measured with respect to time for a predetermined duration. Further, if no class is indicated in the bullying event flag, the autonomous vehicle may be instructed to collect or store default set of sensor data.

In an example, required evidence may include, without limitation, temporal information (e.g., time, date, etc.), vehicle identifiers (e.g., number plate, color, model, make, etc.), sensor data relating to the incident (e.g., tailgating).

In operation 408, a determination is made to optionally collect and/or store supplemental data. In an example, the supplemental data may include, without limitation, weather conditions, lighting conditions, and the like.

In operation 409, the evidence collection algorithm labels the required evidence with an identifier (ID) corresponding to a bullying event. Further, if the supplemental data is also to be collected or stored, the evidence collection algorithm may also label the supplemental evidence with an ID corresponding to the bullying event.

In operation 410, the labeled data are stored in an evidence database of the evidence detection unit.

If no match is determined in operation 405, the sensor data is identified as a candidate bullying signature in operation 420. In an example, a candidate bullying signature may be similar to an attribute of a bullying signature stored in the bullying signature database, but may not match with all of the attributes of a bullying signature. More specifically, a comparison between the comparison data with the bullying signatures may be less than the predetermined tolerance. In another example, the candidate bullying signature may have sensor data indicating aggressive behavior (e.g., driving too closely on adjacent lanes), but may not correspond to a stored bullying signature.

In operation 421, a check is made to determine whether the candidate bullying signature has been previously detected a predetermined number of times. If the candidate bullying signature is determined to have been previously detected at least the predetermined number of times, the candidate bullying signature is verified as a bullying signature in operation 422. Further, the verified bullying signature is added to the bullying signature database in operation 423.

If the candidate bullying signature is determined to have been previously detected less than the predetermined number of times, the candidate bullying signature is stored to a database for future comparisons in operation 424.

Once the labeled data are stored in the evidence database in operation 410, a check is made to determine whether the vehicle identifier of a potential bullying vehicle has been previously identified in operation 430.

If the vehicle identifier has been previously identified in operation 430, an appropriate countermeasure is determined in operation 431. For example, a countermeasure may include, without limitation, modifying the speed or direction of the AV, applying a lighting scheme to provide a visible indication that a bullying event has been detected, providing a warning/explanation to passengers of the autonomous vehicle regarding the bullying event, compiling a report/evidence that can be sent to an authority (e.g., police or insurance company), sending a report to an authority, and the like.

Further, determined countermeasure is applied in operation 432.

If the vehicle identifier has not been previously identified in operation 430, a check is made to determine whether the vehicle identifier is part of a previously identified organization in operation 433. For example, even if the vehicle identifier was not previously identified, but another vehicle belonging to the same organization (e.g., a competitor company) as the vehicle identifier was previously identified, the same organization may be identified as a bullying organization. Further, offending vehicles belonging to the bullying organization may be identified as a bullying vehicle for which countermeasures are to be taken.

If the vehicle identifier is determined to be part of a previously identified organization in operation 433, an appropriate countermeasure is determined in operation 431. Further, determined countermeasure is applied in operation 432.

If the vehicle identifier is determined not to be part of a previously identified organization in operation 433, the vehicle identifier is stored in a database as a candidate bullying vehicle in operation 434.

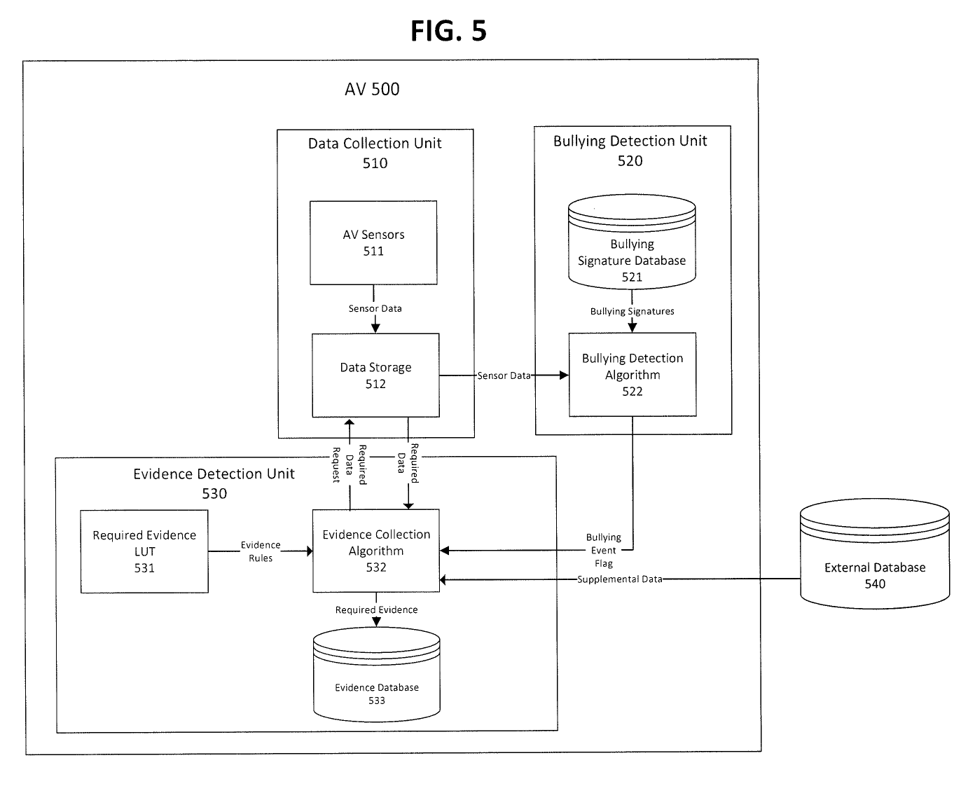

FIG. 5 shows an exemplary data flow for detecting bullying activity, according to an aspect of the present disclosure.

A system included in an autonomous vehicle (AV) 500 for detecting bullying behavior and collecting corresponding evidence, as illustrated in FIG. 5, includes a data collection unit 510, a bullying detection unit 520, and an evidence detection unit 530. However, aspects of the disclosure are not limited thereto, such that some of the above noted units may not be included in the autonomous vehicle or that autonomous vehicle may include additional units. One or more of the above noted units may be implemented as circuits.

The data collection unit 510 includes one or more autonomous vehicle sensors 511 and a data storage 512. The autonomous vehicle sensors 511 may include, without limitation, cameras, a LIDAR (actuators, a light detection and ranging) system, a radar system, acoustic sensors, infrared sensors, image sensors, other proximity sensors, and the like. The one or more autonomous vehicle sensors 511 may collect sensor data of surrounding environment, both static structures and moving objects, and transmits the collected sensor data to the data storage 512. Further, the one or more autonomous vehicle sensors 511 may also collect other relevant information, such as road conditions (e.g., rainy road, snowy road, icy road conditions, and the like). The data storage 512 may store the collected sensor data temporarily. For example, the data storage 512 may temporarily store the collected sensor data per incident or based on a predetermined period.

The bullying detection unit 520 includes a bullying signature database 521 and a bullying detection algorithm 522, which may be executed by a processor. The data storage 512 transmits the sensor data to bullying detection algorithm 522. Further, the bullying detection algorithm 522 requests and retrieves one or more bullying signatures from the bullying signature database 521 for comparison. More specifically, the bullying detection algorithm 522 compares various attributes of the collected sensor data against attributes of the one or more bullying signatures retrieved from the bullying signature database 521.

The bullying detection algorithm 522, after performing the comparison between the collected sensor data and the one or more bullying signatures, determines via a processor whether a bullying event was detected. If the bullying detection algorithm 522 determines that the bullying event was detected, the bullying detection algorithm 522 generates a bullying event flag. In an example, the bullying event flag may also indicate a type or class of bullying event that is detected. Further, the bullying detection algorithm 522 transmits the bullying event flag to an evidence collection algorithm 532 of an evidence detection unit 530.

The evidence detection unit 530 includes a required evidence look-up-table (LUT) 531, an evidence collection algorithm 532, and an evidence database 533. The evidence collection algorithm 532 receives the bullying event flag from the bullying detection algorithm 522. The evidence collection algorithm 532 accesses the required evidence LUT 531 to obtain one or more evidence rules. The obtained evidence rules may specify which sensor data to be collected. In an example, the obtained evidence rules may specify the sensor data to be collected based on the class of the bullying event detected. For example, if the bullying event is determined to be of a tailgating class, a following distance of the instigating vehicle to the autonomous vehicle may be measured with respect to time for a predetermined duration. Further, the obtained one or more evidence rules may additionally and/or optionally specify which supplemental data to be collected.

The evidence collection algorithm 532 transmits, to the data storage 512, a request for required data request corresponding to the one or more evidence rules transmitted to the evidence collection algorithm 532. The data storage 512, in response the request for the required data, transmits the required data to the evidence collection algorithm 532.

Once the evidence collection algorithm 532 receives all of the required data, the evidence collection algorithm 532 transmits the received data as evidence of the bullying event to an evidence database 533.

Although aspects of the present disclosure have been provided with respect to an autonomous vehicles, aspects of the present disclosure are not limited thereto such that the above noted embodiments may be applicable to human-driven vehicles where the vehicles being driven are equipped with sufficient on-board sensors capable of detecting bullying signatures (e.g., vehicles with level 1 or above automation.

Further, although aspects of the present disclosure have been provided from a perspective of the autonomous vehicle, aspects of the present disclosure are not limited thereto such that an autonomous vehicle may observe bullying behaviour that is acted upon another vehicle. Accordingly, the autonomous vehicle may operate as a monitoring vehicle to observe interactions of other vehicles with one another.

Further, although the sensor data of surrounding environment is collected by the autonomous vehicle sensor 321 of the AV in aspects of the present disclosure, the sensor data of surrounding environment may be collected by an autonomous vehicle sensor provided in other vehicle.

Further, although the evidences stored in the evidence database 533 illustrated in FIG. 5 may be ranked based on degree of bullying events. In the operation 431 illustrated in FIG. 4C, one appropriate countermeasure may be determined among different kinds of appropriate countermeasures based on the evidence ranked with the degree of the bullying events.

Based on aspects of the present disclosure, several technological benefits or improvements may be realized. In an example, an ability to know when a vehicle that is at least partially algorithmically controlled has been bullied. Further, ability to collected data for carrying out an appropriate countermeasure to the bullying vehicle, and controlling an autonomous vehicle to carry out the appropriate countermeasure. Also, the autonomous vehicle may be able to collate data over multiple events to better identify an individual's or an organization's bullying behaviour, or identify bullying behaviour in multiple vehicles controlled by the same algorithms.

Aspects of the present disclosure provide an exemplary use a variety of sensors mounted on an autonomous vehicle to gather data on the manner other vehicles are being driven. Further, aspects of the present disclosure correlate driving interactions of other vehicles, the interactions being stimuli received by an autonomous vehicle, with reactions of the autonomous vehicle. Also, aspects of the present disclosure provide capturing and storing of evidence to indicate that the driving interactions of other vehicles are being deliberately performed in order to make the autonomous vehicle receiving the stimuli to act in a non-optimal manner.

In addition, aspects of the present disclosure may provide a technical solution to a problem that in such a situation the automated system subjected to the stimuli provided by other vehicles (i) may not know that a bullying action has taken place, (ii) may not know who the perpetrator of the bullying action is, and/or (iii) may not unable to collect adequate evidence of the bullying action in order to carry out a corrective action.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a method is provided for detecting a bullying event. The method includes collecting, using a plurality of autonomous vehicle (AV) sensors provided on the AV, sensor data of an interaction between the AV and another vehicle; storing, in a memory, the collected sensor data; retrieving, from the memory, a bullying signature; comparing, via a processor, the collected sensor data and attributes of the bullying signature; when a similarity between the collected sensor data and the attributes of the bullying signature is determined to be above a predetermined threshold, determining that the collected sensor data corresponds to a bullying event; and generating a bullying event flag for the bullying event.

According to another aspect of the present disclosure, the bullying event flag indicates a specific class of bullying event.

According to yet another aspect of the present disclosure, the method further includes retrieving, from the memory, an evidence rule for the bullying event; transmitting, to the memory, a request for sensor data corresponding to the evidence rule; retrieving, from the memory, the requested sensor data; and storing, in the memory, the retrieved sensor data as evidence for the bullying event.

According to still another aspect of the present disclosure, the method further includes retrieving, from an external database via a network, supplemental data corresponding to the evidence rule; and storing, in the memory, the retrieved supplemental data as a part of the evidence for the bullying event.

According to another aspect of the present disclosure, the method further includes identifying the evidence as a candidate bullying signature.

According to another aspect of the present disclosure, the method further includes ranking the evidence for the bullying event based on degree of bulling events, and storing, in the memory, the evidence ranked with the degree of the bullying events.

According to yet another aspect of the present disclosure, the method further includes determining whether the candidate bullying signature has been detected at least a predetermined number of times; when the candidate bullying signature has been detected at least the predetermined number of times, verifying the candidate bullying signature as a valid bullying signature, and adding the valid bullying signature to the memory; and when the candidate bullying signature has been detected less than the predetermined number of times, storing the candidate bullying signature for subsequent verification.

According to still another aspect of the present disclosure, the retrieved sensor data includes a vehicle identifier of the other vehicle instigating the bullying event.

According to another aspect of the present disclosure, the method further includes determining whether the other vehicle has been previously identified; and when the other vehicle has been previously identified, determining a countermeasure for the bullying event.

According to yet another aspect of the present disclosure, when the other vehicle has not been previously identified, storing the other vehicle as a candidate bullying vehicle.

According to still another aspect of the present disclosure, the method further includes when the other vehicle has not been previously identified, determining whether the other vehicle is part of a previously identified organization; when the other vehicle is part of the previously identified organization, determining a countermeasure for the bullying event; and when the other vehicle is not part of the previously identified organization, storing the other vehicle as the candidate bullying vehicle.

According to another aspect of the present disclosure, the countermeasure includes at least one of: modifying a driving operation of the AV, applying a lighting scheme to provide a visible indication, providing a notification of the bullying event to a passenger of the AV, and sending a report to an authority.

According to yet another aspect of the present disclosure, the bullying event includes at least one of: tailgating, aggressive braking in front of AV, and passing the AV with excessive speed.

According to still another aspect of the present disclosure, the method further includes determining the interaction to be a candidate bullying event when the interaction causes the AV to operate less efficiently by at least a predetermined threshold.

According to still another aspect of the present disclosure, the supplemental data includes at least one of weather conditions, and lighting conditions at a time of the bullying event.

According to still another aspect of the present disclosure, the attributes of the bullying signature includes at least one of: a distance between the AV and an instigating vehicle, an angle of approach of the instigating vehicle, a velocity of approach by the instigating vehicle, and a rate of change in velocity of the instigating vehicle.

According to still another aspect of the present disclosure, the evidence further includes at least one of: unexpected changes in direction, change in arrival time, and unexpected change in speed.

According to still another aspect of the present disclosure, the sensor data includes sensor data collected from: at least one image sensor, at least one LIDAR (actuators, a light detection and ranging) sensor, and at least one radar sensor.

According to still another aspect of the present disclosure, the determination of the bullying event is made in view of an environmental condition.

According to another aspect of the present disclosure, a non-transitory computer readable storage medium that stores a computer program, the computer program, when executed by a processor, causing a computer apparatus to perform a process for detecting a bullying event. The process includes collecting, using a plurality of autonomous vehicle (AV) sensors provided on the AV, sensor data of an interaction between the AV and another vehicle; storing, in a memory, the collected sensor data; retrieving, from the memory, a bullying signature; comparing, via a processor, the collected sensor data and attributes of the bullying signature; when a similarity between the collected sensor data and the attributes of the bullying signature is determined to be above a predetermined threshold, determining that the collected sensor data corresponds to a bullying event; and generating a bullying event flag for the bullying event.

According to yet another aspect of the present disclosure, a computer apparatus for detecting a bullying event is provided. The computer apparatus includes a memory that stores instructions, and a processor that executes the instructions, in which, when executed by the processor, the instructions cause the processor to perform a set of operations. The set of operations includes collecting, using a plurality of autonomous vehicle (AV) sensors provided on the AV, sensor data of an interaction between the AV and another vehicle; storing the collected sensor data; retrieving a bullying signature; comparing the collected sensor data and attributes of the bullying signature; when a similarity between the collected sensor data and the attributes of the bullying signature is determined to be above a predetermined threshold, determining that the collected sensor data corresponds to a bullying event; and generating a bullying event flag for the bullying event.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for detecting a bullying event by an autonomous vehicle (AV), the method comprising:
collecting, using a plurality of autonomous vehicle (AV) sensors provided on the AV, sensor data of an interaction between the AV and another vehicle;
storing, in a memory, the collected sensor data;
retrieving, from the memory, a bullying signature;
comparing, via a processor, the collected sensor data and attributes of the bullying signature;
when a similarity between the collected sensor data and the attributes of the bullying signature is determined to be above a predetermined threshold, determining that the collected sensor data corresponds to a bullying event; and
generating a bullying event flag for the bullying event.

2. The method of claim 1, wherein the bullying event flag indicates a specific class of bullying event.

3. The method of claim 1, further comprising:
retrieving, from the memory, an evidence rule for the bullying event;
transmitting, to the memory, a request for sensor data corresponding to the evidence rule;
retrieving, from the memory, the requested sensor data; and
storing, in the memory, the retrieved sensor data as evidence for the bullying event.

4. The method of claim 3, further comprising:
retrieving, from an external database via a network, supplemental data corresponding to the evidence rule; and
storing, in the memory, the retrieved supplemental data as a part of the evidence for the bullying event.

5. The method of claim 3, further comprising:
identifying the evidence as a candidate bullying signature.

6. The method of claim 3, further comprising:
ranking the evidence for the bullying event based on degree of bulling events, and storing, in the memory, the evidence ranked with the degree of the bullying events.

7. The method of claim 5, further comprising:
determining whether the candidate bullying signature has been detected at least a predetermined number of times;
when the candidate bullying signature has been detected at least the predetermined number of times, verifying the candidate bullying signature as a valid bullying signature, and adding the valid bullying signature to the memory; and
when the candidate bullying signature has been detected less than the predetermined number of times, storing the candidate bullying signature for subsequent verification.

8. The method of claim 3, wherein the retrieved sensor data includes a vehicle identifier of the other vehicle instigating the bullying event.

9. The method of claim 8, further comprising:
determining whether the other vehicle has been previously identified; and
when the other vehicle has been previously identified, determining a countermeasure for the bullying event.

10. The method of claim 9, wherein, when the other vehicle has not been previously identified, storing the other vehicle as a candidate bullying vehicle.

11. The method of claim 9, further comprising:
when the other vehicle has not been previously identified, determining whether the other vehicle is part of a previously identified organization;
when the other vehicle is part of the previously identified organization, determining a countermeasure for the bullying event; and
when the other vehicle is not part of the previously identified organization, storing the other vehicle as the candidate bullying vehicle.

12. The method of claim 9, wherein the countermeasure includes at least one of:
modifying a driving operation of the AV,
applying a lighting scheme to provide a visible indication,
providing a notification of the bullying event to a passenger of the AV, and
sending a report to an authority.

13. The method of claim 1, wherein the bullying event includes at least one of:
tailgating,
aggressive braking in front of AV, and
passing the AV with excessive speed.

14. The method of claim 1, further comprising:
determining the interaction to be a candidate bullying event when the interaction causes the AV to operate less efficiently by at least a predetermined threshold.

15. The method of claim 4, wherein the supplemental data includes at least one of weather conditions, and lighting conditions at a time of the bullying event.

16. The method of claim 1, wherein the attributes of the bullying signature includes at least one of:
a distance between the AV and an instigating vehicle,
an angle of approach of the instigating vehicle,
a velocity of approach by the instigating vehicle, and
a rate of change in velocity of the instigating vehicle.

17. The method of claim 3, wherein the evidence further includes at least one of:
unexpected changes in direction,
change in arrival time, and
unexpected change in speed.

18. The method of claim 1, wherein the sensor data includes sensor data collected from:
at least one image sensor,
at least one LIDAR (actuators, a light detection and ranging) sensor, and
at least one radar sensor.

19. The method of claim 1,
wherein the determination of the bullying event is made in view of an environmental condition.

20. A non-transitory computer readable storage medium that stores a computer program, the computer program, when executed by a processor, causing a computer apparatus to perform a process for detecting a bullying event, the process comprising:
collecting, using a plurality of autonomous vehicle (AV) sensors provided on the AV, sensor data of an interaction between the AV and another vehicle;
storing, in a memory, the collected sensor data;
retrieving, from the memory, a bullying signature;
comparing, via a processor, the collected sensor data and attributes of the bullying signature;
when a similarity between the collected sensor data and the attributes of the bullying signature is determined to be above a predetermined threshold, determining that the collected sensor data corresponds to a bullying event; and
generating a bullying event flag for the bullying event.

21. A computer apparatus for detecting a bullying event, the computer apparatus comprising:
a memory that stores instructions, and
a processor that executes the instructions,
wherein, when executed by the processor, the instructions cause the processor to perform operations comprising:
collecting, using a plurality of autonomous vehicle (AV) sensors provided on the AV, sensor data of an interaction between the AV and another vehicle;
storing the collected sensor data;
retrieving a bullying signature;
comparing the collected sensor data and attributes of the bullying signature;
when a similarity between the collected sensor data and the attributes of the bullying signature is determined to be above a predetermined threshold, determining that the collected sensor data corresponds to a bullying event; and
generating a bullying event flag for the bullying event.
